(19) United States
(12) Patent Application Publication
(10) Pub. No.: US 2013/0169793 A1
(43) Pub. Date: Jul. 4, 2013

(54) INSPECTION SYSTEM AND INSPECTION METHOD

(71) Applicant: SHIBAURA MECHATRONICS CORPORATION, Yokohama-shi (JP)

(72) Inventors: Yoshinori HAYASHI, Yokohama-shi (JP); Osamu IZUTSU, Yokohama-shi (JP); Hiroshi WAKABA, Yokohama-shi (JP); Yoko ONO, Yokohama-shi (JP); Katsutoshi SEKI, Yokohama-shi (JP); Takanori GONDO, Yokohama-shi (JP); Akihiko TAKIZAWA, Yokohama-shi (JP)

(73) Assignee: SHIBAURA MECHATRONICS CORPORATION, Yokohama-shi (JP)

(21) Appl. No.: 13/729,441

(22) Filed: Dec. 28, 2012

(30) Foreign Application Priority Data
Dec. 31, 2011 (JP) 2011-290497
Mar. 9, 2012 (JP) 2012-052755

(51) Int. Cl. H04N 7/18

(52) U.S. Cl. CPC H04N 7/18
USPC 348/125

(57) ABSTRACT

An inspection system captures an inspected object which is illuminated by an illumination system and processes an image of the inspected object which is expressed by the obtained image data to inspect it. The inspection system includes a processing information determining portion determining processing information which is used for the inspection processing which changes along with the change of the amount of illumination light from the illumination system from the initial amount of light to the target amount of light when the set amount of light of the illumination system is changed from the initial amount of light to the target amount of light, and which system performs the inspection processing by using processing information which is determined by the processing information determining means in accordance with the elapsed time from when the set amount of light of the illumination system is switched to the target amount of light.

### TECHNICAL FIELD

The present invention relates to an inspection system and inspection method which capture an illuminated inspected object and use the captured image as the basis to inspect the inspected object.

### BACKGROUND ART

In the past, there has been known the defect inspection system of a transparent sheet member which is described in PLT 1. In this defect inspection system (inspection system), an inspected object, that is, a transparent sheet member, is illuminated by an illumination device which is arranged at one surface side of that inspected transparent sheet member. In that state, a CCD camera which is arranged at the other surface side of the transparent sheet member is used to capture that transparent sheet member. Further, the image which is captured by the CCD camera is processed to thereby detect scratches or other defects in the transparent sheet member.

In the illumination device, a halogen lamp, xenon lamp, high pressure mercury lamp, sodium lamp, etc. is used as a light source. Further, a suitable amount of illumination light of the illumination device is determined to enable an image enabling scratches and other defects to be discerned to be captured by the CCD camera.

### CITATIONS LIST

### Patent Literature

PLT 1: Japanese Patent Publication No. 2001-141662 A1

### SUMMARY OF THE INVENTION

### Technical Problem

In this regard, due to the high amount of illumination light and, further, long lifetime and other advantages, use of the known high brightness LEDs as the light source of the illumination system may be considered. An illumination system which uses such high brightness LEDs as a light source is structured to maintain a high amount of illumination light by, as one example, sealing a plurality of LEDs (light emitting diodes) by a resin in which a phosphor is mixed. However, when emitting light by an initially set initial amount of light and then, in that state, switching the set amount of light to a target amount of light, due to the presence of the phosphor, the structure which is explained above, etc., a relatively long time is taken for the actual amount of illumination light to become the target amount of light (for example, sometimes 20 minutes or so are taken). For this reason, when it is necessary to change the amount of illumination light along with a change in the type of the inspected object, time ends up being taken until the suitable amount of illumination light is reached and therefore the inspection after the change of type of object ends up being delayed. On the other hand, if starting an inspection before the suitable amount of illumination light is reached, good precision inspection would be difficult.

The present invention was made in consideration of such a situation and provides an inspection system and an inspection method which enable good precision inspection compared with the past even if using an illumination system which requires a relatively long time for the amount of illumination light to reach a target amount of light when switching the set amount of light to the target amount of light like in an illumination system using high brightness LEDs etc. as a light source (that is, which is poor in response to switching of the set amount of light) and starting the inspection before the amount of illumination light of the illumination system reaches the target amount of light.

### Solution to Problem

The inspection system according to the present invention is an inspection system which has an illumination system which illuminates an inspected object, a camera unit which captures the inspection object which is illuminated by the illumination system to output an image signal, and a processing unit which uses the image signal from the camera unit as the basis to generate image data which expresses an image of the inspected object and processes the image of the inspected object which is expressed by the image data for inspection, the processing unit having a processing information determining unit determining processing information which is used for the inspection processing which changes along with the change of the amount of illumination light from the illumination system from the initial amount of light to the target amount of light when the set amount of light of the illumination system is changed from the initial amount of light to the target amount of light, wherein the processing unit performs the inspection processing by using processing information which is determined by the processing information determining portion in accordance with the elapsed time from when the set amount of light of the illumination system is switched from the initial amount of light to the target amount of light.

Due to such a constitution, when the set amount of light of the illumination system is switched from the initial amount of light to the target amount of light, the inspection processing on the image of the inspected object which is expressed by the image data which is produced based on the image signal from the camera unit is performed using the processing information which changes in accordance with the change of the amount of illumination light from the illumination system from the initial amount of light to the target amount of light.

In the inspection system according to the present invention, the processing unit uses the processing information constituted by the image inspection criteria as the basis to process the image of the inspected object which is expressed by the image data for inspection. The processing information determining unit can be constituted so as to determine the image inspection criteria which changes in accordance with the change of the amount of illumination light from the illumination system from the initial amount of light to the target amount of light.

Further, the processing information determining unit, for example, can have a portion for determining a correction coefficient of the image data which changes in accordance with the change of the amount of illumination light of the illumination system from the initial amount of light to the target amount of light and can use the correction coefficient to determine the image data which is used for the inspection processing which changes along with the change in the amount of illumination light from the illumination system from the initial amount of light to the target amount of light.

Furthermore, the processing information determining unit, for example, can have a portion for determining gain information of the image signal from the camera unit which changes in accordance with the change of the amount of illumination light of the illumination system from the initial amount of light to the target amount of light and can use the gain information to adjust the level of the image signal which is used for the inspection processing which changes along with the change in the amount of illumination light from the illumination system from the initial amount of light to the target amount of light.

An inspection method according to the present invention is an inspection method which performs an inspection processing to an image of an inspected object which is expressed by image data obtained by capturing the inspected object by a camera unit, the inspected object being illuminated by an illumination system, the inspection method comprising a processing information determining step of determining processing information which is used for the inspection processing which changes along with the change of the amount of illumination light from the illumination system from the initial amount of light to the target amount of light when the set amount of light of the illumination system is changed from the initial amount of light to the target amount of light and an inspection processing execution step of performing the inspection processing by using processing information which is determined by the processing information determining step in accordance with the elapsed time from when the set amount of light of the illumination system is switched from the initial amount of light to the target amount of light.

### Advantageous Effects of Invention

According to the present invention, when the set amount of light of the illumination system is switched from the initial amount of light to the target amount of light, the inspection processing is performed by using processing information which changes when the amount of illumination light from the illumination system changes from the initial amount of light to the target amount of light, so it is possible to perform good precision inspection compared with the past even if using an illumination system which requires a relatively long time for the amount of illumination light to reach a target amount of light when switching the set amount of light to the target amount of light like in an illumination system using high brightness LEDs etc. as a light source (that is, which is poor in response to switching of the set amount of light) and starting the inspection before the amount of illumination light of the illumination system reaches the target amount of light.

### BRIEF DESCRIPTION OF THE DRAWINGS

Other objects, features and advantages of the present invention will become more apparent from the following detailed description when read in conjunction with the accompanying drawings, in which:

FIG. 1A is a cross-sectional view which shows the structure of a sensor panel assembly (bonded plate-shaped member) which is inspected by an embodiment of the inspection system according to the present invention;

FIG. 1B is a plan view which shows the structure of the sensor panel assembly;

FIG. 1C is a cross-sectional view which shows the structure of a touch panel type of liquid crystal panel comprised of the sensor panel assembly which is shown in FIG. 1A and FIG. 1B and a liquid crystal panel assembly bonded together by a binder;

FIG. 2 is a view which shows the basic constitution of the inspection system according to an embodiment of the present invention;

FIG. 3 is a view which shows the structure of a light source device which is included in the illumination system which is used in the inspection system which is shown in FIG. 2;

FIG. 4 is a view of a basic constitution of a processing system of the inspection system according to an embodiment of the present invention;

FIG. 5A is a view which shows an example of the changed characteristic of the amount of illumination light when switching the set amount of light of the illumination system from the initial amount of light to a target amount of light which is lower than that.

FIG. 5B is a view which shows an example of the changed characteristic of the amount of illumination light when switching the set amount of light of the illumination system from the initial amount of light to a target amount of light which is higher than that;

FIG. 6 is a flow chart which shows the flow of processing for producing a correction information file;

FIG. 7 is a flow chart which shows the flow of processing for correction of a recipe (processing information) when switching the set amount of light of the illumination system; and

FIG. 8 is a view of a basic constitution of a processing system of the inspection system according to another embodiment of the present invention.

### DESCRIPTION OF THE EMBODIMENTS

Embodiments of the present invention will be explained with reference to the accompanying drawings.

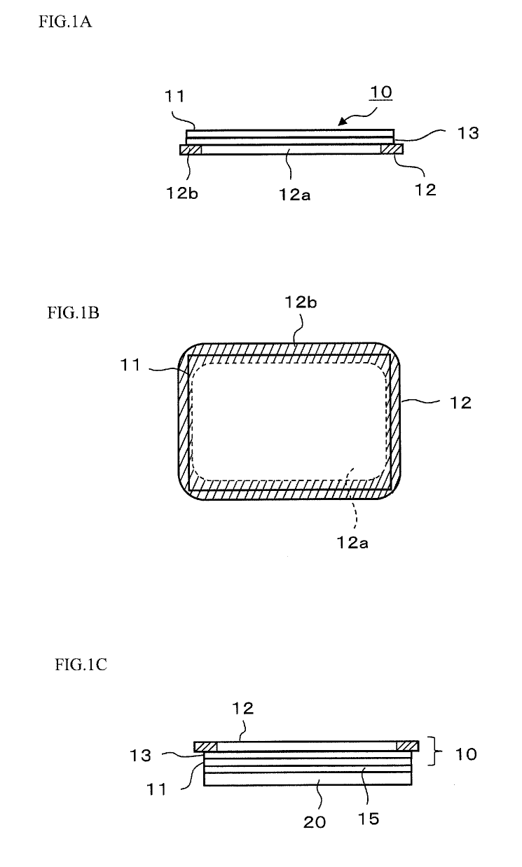

An object which is inspected by an inspection system according to an embodiment of the present invention (inspected object) will be explained while referring to FIG. 1A to FIG. 1C. This example is a sensor panel assembly which is used for a touch panel type of liquid crystal display panel. Note that, FIG. 1A is a cross-sectional view which shows the structure of a sensor panel assembly 10, FIG. 1B is a plan view which shows the structure of the sensor panel assembly 10, and FIG. 1C is a cross-sectional view which shows the structure of a touch panel type of liquid crystal panel comprised of the sensor panel assembly 10 and a liquid crystal panel assembly 20 bonded together by a binder.

In FIG. 1A and FIG. 1B, this sensor panel assembly 10 is structured comprised by a sensor panel 11 on which sensor devices or a grid or other circuit components are formed in an array and a cover glass 12 which are bonded together by a binder 13 (resin) which is coated over the entire surface of the sensor panel 11 and has light transmittancy. The sensor panel 11 is structured comprised by a glass substrate on which circuit components are formed and overall forms a light transmitting region which has light transmittancy (however, parts of circuit components not transmitting light). Further, the cover glass 12 has a periphery which forms a predetermined width of non-light transmitting region 12b (black region). The region inside of that forms a light transmitting region 12a which has light transmittancy.

Such a structure of a sensor panel assembly 10, as shown in FIG. 1C, is bonded by a binder 15 which has light transmittancy with respect to the liquid crystal panel assembly 20 (comprised of liquid crystal panel, color filter, polarizer, etc.). In the thus formed touch panel type of liquid crystal display panel, the liquid crystal panel assembly 20 is used to display an image, and sensor devices on the sensor panel 11 which correspond to positions on the cover glass 12 which are touched by the finger are used to output signals. Further, the signals which are output from the sensor devices of this sensor panel 11 can be used to control the display of the image by the liquid crystal panel assembly 20.

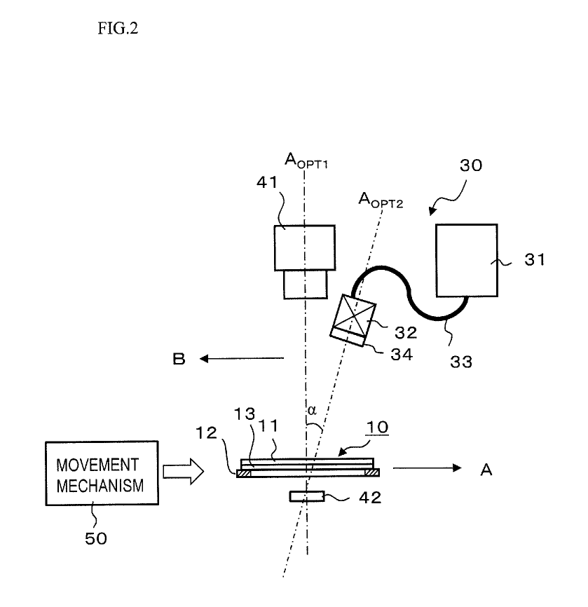

In the process of producing the above-mentioned such structure of sensor panel assembly 10, sometimes bubbles will form inside of the binder 13 or dust or other foreign matter will enter the binder 13. Further, sometimes the binder 13 will be squeezed out from between the sensor panel 11 and the cover glass 12 or the binder 13 will become insufficient. An inspection system for inspecting for such defects in the sensor panel assembly 10 is, for example, constituted as shown in FIG. 2.

In FIG. 2, this inspection system has a line sensor camera 41 (camera unit) which forms a camera unit, an illumination unit 30 (illumination system), a reflector 42, and a movement mechanism 50. The movement mechanism 50 makes a sensor panel assembly 10 which has been set on a path of movement in a state with the sensor panel 11 facing upward and the cover glass 12 facing downward move linearly by a predetermined speed. The line sensor camera 41, for example, includes a line sensor which is constituted by a string of CCD elements and a group of lenses (able to include lens for enlargement for broadening field of view) and other parts of an optical system and is arranged fastened so as to face the sensor panel 11 of the sensor panel assembly 10 on the path of movement. Further, the posture of the line sensor camera 41 is adjusted so that the direction in which the line sensor (string of CCD elements) of this line sensor camera 41 extends cuts across a movement direction A of the sensor panel assembly 10 (for example, perpendicularly intersects the movement direction A) and so that its optical axis A_{OPT1} perpendicularly intersects the surface of the sensor panel assembly 10 (sensor panel 11). The reflector 42 has a reflection surface which is processed to reflect incident light by diffused reflection and is arranged fastened near the sensor panel assembly 10 on the path of movement so that the reflection surface faces the cover glass 12 of the sensor panel assembly 10. Due to the reflected light at the thus arranged reflector 42, light is illuminated from the cover glass 12 side of the sensor panel assembly 10 toward the line sensor camera 41.

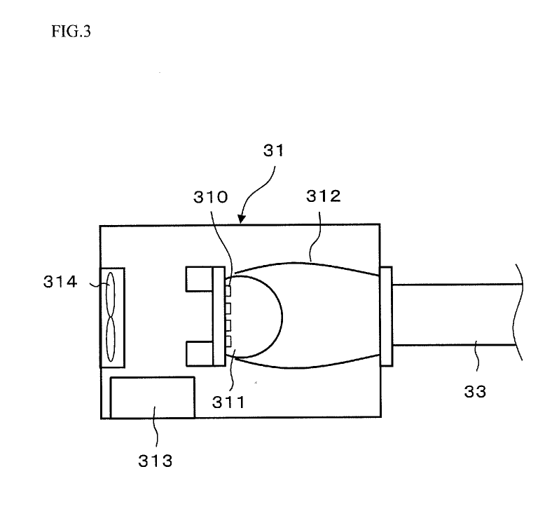

The illumination unit 30 has a light source device 31, an illumination head 32, a light guide 33 which guides the light emitted from the light source device 31 to the illumination head 32, and a light condenser 34 which is bonded to the emission surface of the light of the illumination head 32 and enables adjustment of the focusing position. The light source device 31, for example, as shown in FIG. 3, has a high brightness LED unit 311, a light guide mirror 312, a power source unit 313, and a cooling fan 314. The high brightness LED unit 311 is structured comprised of a large number of LEDs 310 (light emitting diodes) sealed by a resin containing a phosphor. The high brightness LED unit 311 receives electric power from the power source unit 313, makes the individual LEDs 310 emit light, and uses the light emission of the phosphor accompanying this to illuminate the entire resin sealed assembly with light. The light which is emitted from the high brightness LED unit 311 is guided by the light guide mirror 312 to strike the end of the light guide 33. This light is propagated along the light guide 33 and emitted from the illumination head 32 (see FIG. 2). The high brightness LED unit 311 which contains the large number of light emitting LEDs 310 is cooled by the cooling fan 314 whereby its operating temperature is kept within a prescribed temperature range.

The illumination head 32 of the illumination unit 30 is arranged at the downstream side of the line sensor camera 41 in the movement direction A of the sensor panel assembly 10 on the path of movement, that is, at the upstream side of the line sensor camera 41 in the scan direction B of the line sensor camera 41, so as to face the sensor panel 11. The posture of the illumination head 32 is adjusted so as to illuminate the surface of the sensor panel assembly 10 from a slant above the sensor panel assembly 10, specifically, from a direction whereby the optical axis A_{OPT2} becomes a predetermined angle α with respect to the normal direction of the surface of the sensor panel assembly 10 (sensor panel 11) without cutting across the optical axis A_{OPT1} of the line sensor camera 41. Due to such adjustment, part of the light which is emitted from the illumination head 32 of the illumination unit 30 is reflected at the surface of the inspected sensor panel assembly 10 and strikes the line sensor camera 41. Further, another part of the light which is emitted from the illumination head 32 passes through the sensor panel assembly 10 and is reflected at the reflector 42 by diffused reflection. Part of the diffused reflected light then passes through the sensor panel assembly 10 and strikes the line sensor camera 41.

In such a structure of an inspection system, the movement mechanism 50 is used so that the sensor panel assembly 10 moves on the path of movement in the direction A, whereby the relative positional relationship between the line sensor camera 41 and the illumination head 32 is maintained while making the line sensor camera 41 optically scan the sensor panel assembly 10 in the reverse direction to the movement direction A. Due to this scan, the line sensor camera 41 captures the sensor panel assembly 10.

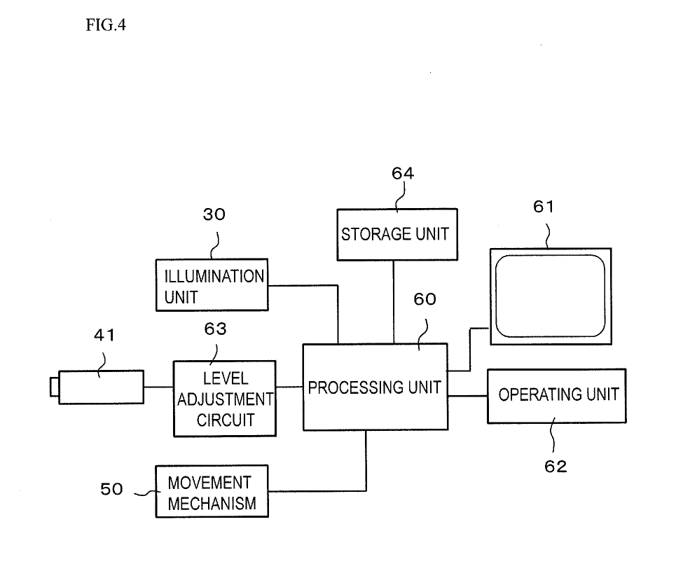

The processing system of the inspection system is constituted as shown in FIG. 4.

In FIG. 4, the processing unit 60 is connected to the line sensor camera 41 through a level adjustment circuit 63 and is connected to a display unit 61, an operating unit 62, a storage unit 64, and, furthermore, the illumination unit 30 (light source device 31). The processing unit 60, synchronized with movement of the sensor panel assembly 10 (inspected object) by the movement mechanism 50, receives as input an image signal from the line sensor camera 41 which optically scans the sensor panel assembly 10 through the level adjustment circuit 63 and uses the level adjusted image signal as the basis to produce test image data which expresses an image of the sensor panel assembly 10. The level adjustment circuit 63 uses gain information which is set in accordance with control of the processing unit 60 to adjust the level of the image signal which is output from the line sensor camera 41.

The processing unit 60 performs control to adjust the light of the illumination system 30. This control for adjustment of light is performed by switching the electric power which is supplied from the power source unit 313 of the illumination unit 30 (see FIG. 3) to the high brightness LED unit 311. Due to this switching of the electric power, the set amount of light of the illumination unit 30 is switched from the current amount of light (below, referred to as the initial amount of light) to the target amount of light.

The processing unit 60 uses the produced test image data as the basis to make the display unit 61 display an image of the sensor panel assembly 10 and, further, uses that test image data to perform inspection processing. This inspection processing is performed on the image of the sensor panel assembly 10 which is expressed by the test image data based on various types of threshold levels which express judgment criteria for the edges of the sensor panel assembly 10 in the image etc., judgment criteria for judging image parts as bubbles, scratches, and other defect, and various other criteria expressed in a recipe (image inspection criteria). The recipe is determined for each type of inspected sensor panel assembly 10 and is stored in the storage unit 64 linked with the product type. Note that, the processing unit 60 can acquire the information relating to the various instructions corresponding to operations of the operating unit 62 and can make the results of the inspection processing, that is, information relating to the inspection results, be displayed at the display unit 61.

In control for adjustment of light of the illumination unit 30 which includes the high brightness LED unit 311, when switching the set amount of light form the initial amount of light Iᵢₙₜ to the target amount of light I_{tgt}, time is taken until the actual amount of illumination light of the illumination unit 30 reaches the target amount of light I_{tgt}. This is due, as explained above, to the presence of the phosphor and the large number of LEDs 310 in the high brightness LED unit 311 sealed by a resin containing a phosphor (see FIG. 3). Note that, the amount of light of the illumination unit 30 (the set amount of light and the amount of illumination light) can be expressed by the amount of light emitted by the light source device 31, the brightness of the illuminated location of the inspected sensor panel assembly 10, or the amount of light received by the line sensor camera 41 (output levels of pixels of line sensor camera 41).

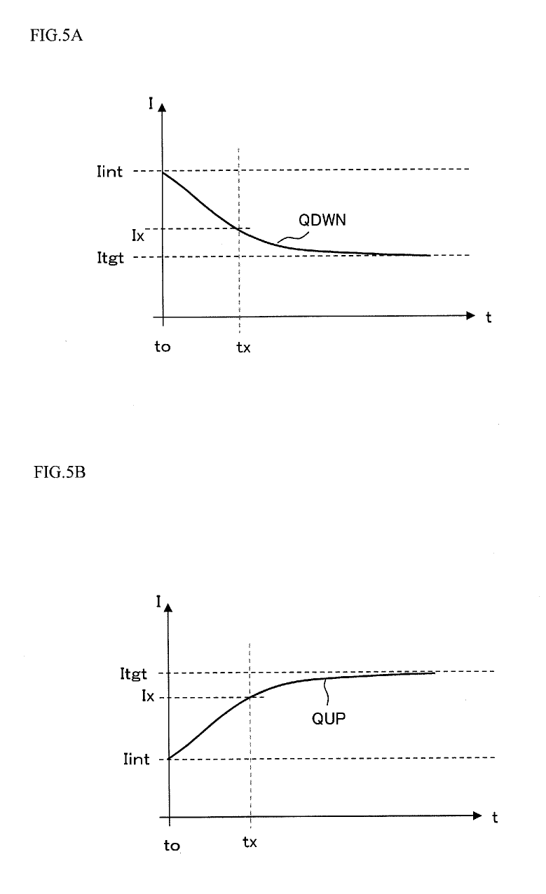

For example, as shown in FIG. 5A, if the set amount of light is switched from the initial amount of light Iᵢₙₜ to a target amount of light I_{tgt} lower than that, the actual amount of illumination light I gradually falls in accordance with the characteristic QDWN and reaches the target amount of light I_{tgt} in accordance with the elapsed time from the time it is switched (for example, 20 minutes of time is taken). Under the situation where illumination is performed by the amount of illumination light Iₓ of before the amount of illumination light reaches the target amount of light I_{tgt} (for example, after the time (tₓ-tₒ) elapsed from the switching time tₒ), the illumination is performed by the amount of illumination light larger than the target amount of light I_{tgt}, so the image which is expressed by the obtained test image data is brighter than the image suitable for the inspection processing. On the other hand, as shown in FIG. 5B, if the set amount of light is switched from the initial amount of light Iᵢₙₜ to a higher target amount of light I_{tgt}, the actual amount of illumination light I gradually increases in accordance with the characteristic QUP and reaches the target amount of light I_{tgt} in accordance with the elapsed time from the time it is switched. Under the situation where illumination is performed by the amount of illumination light Iₓ of before the amount of illumination light reaches the target amount of light I_{tgt} (for example, after the time (tₓ-tₒ) elapsed from the switching time tₒ), the illumination is performed by the amount of illumination light smaller than the target amount of light I_{tgt}, so the image which is expressed by the obtained test image data is darker than the image suitable for the inspection processing.

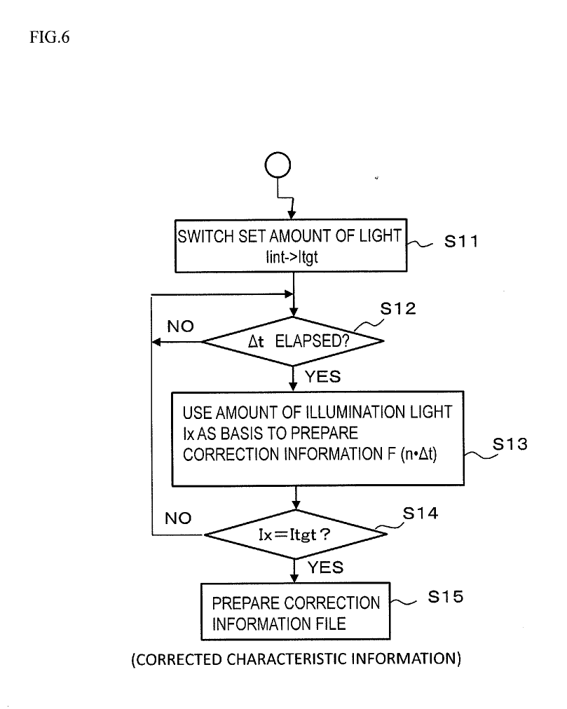

Correction information F of the recipe is prepared as processing information to be used for the inspection processing to enable suitable inspection even if the image which is expressed by the test image data which is obtained in the period from when the set amount of light of the illumination unit 30 is switched from the initial amount of light Iᵢₙₜ to the target amount of light I_{tgt} to when the actual amount of illumination light reaches the target amount of light I_{tgt} is brighter or darker in state than the image which is suitable for inspection processing. This corrected information F is prepared in accordance with the routine which is shown in FIG. 6.

First, patterns of switching the set amounts of light at the times of switching the types of the sensor panel assembly 10 being inspected (patterns of switching from the initial amount of light Iᵢₙₜ to the target amount of light I_{tgt}) are extracted from a preset inspection schedule (for example, types of inspected objects and inspection order). A set of correction information F for all of the patterns (correction information file) is prepared.

In FIG. 6, the set amount of light of the illumination unit 30 is switched from the initial amount of light Iᵢₙₜ to the target amount of light I_{tgt} (S11). This being so, the amount of the light which is actually emitted from the illumination unit 30 (the amount of illumination light) gradually changes from the initial amount of light Iᵢₙₜ (see FIG. 5A, FIG. 5B). In the process, each time a predetermined time At (for example, 5 minutes) elapses (at S12, YES), the test image data (corresponding to image of sensor panel assembly 10) which is obtained based on the image signal from the line sensor camera 41 which scans the sensor panel assembly 10 which is illuminated by the amount of illumination light Iₓ at that time is used as the basis to prepare correction information F for the recipe to be used at the time of the target amount of light I_{tgt} (S13). In this way, until the amount of illumination light of the illumination unit 30 reaches the target amount of light I_{tgt} (at S14, YES), the correction information F is repeatedly prepared. Further, if the amount of illumination light of the illumination unit 30 reaches the target amount of light I_{tgt} (at S14, YES), a correction information file comprised of the correction information F obtained up to then linked with the elapsed time (n·Δt) from when the set amount of light is changed from the initial amount of light I_{Int} to the target amount of light I_{tgt} is prepared (S15). The correction information file including the plurality of correction information F which is linked with the elapsed time (for the plurality of the elapsed time periods) is stored in the storage unit 64 (storage means) linked with the original recipe determined by the target amount of light I_{tgt}.

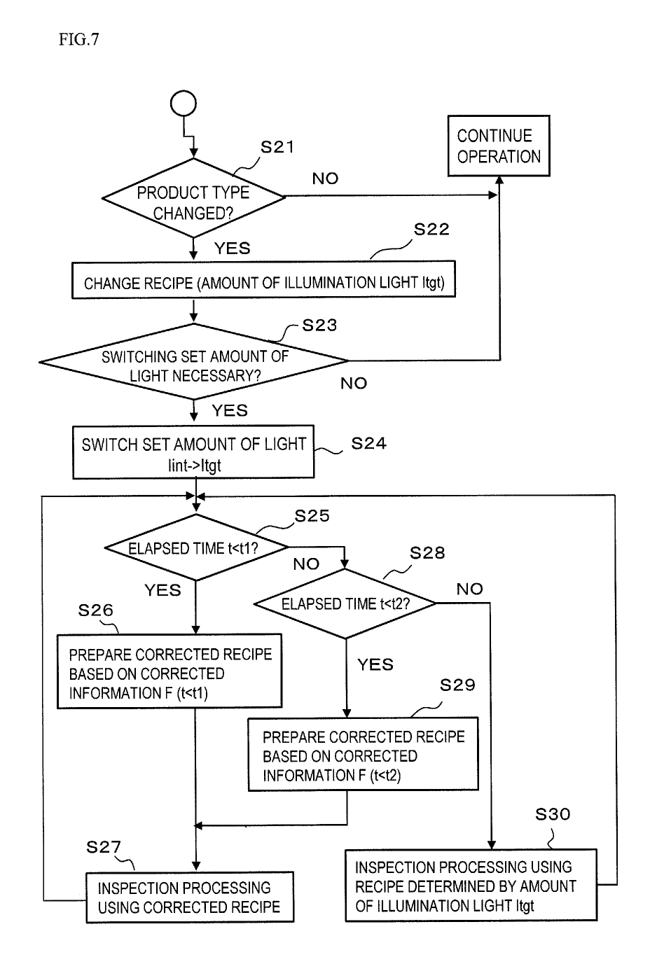

In the process of actually operating the inspection system, when the set amount of light of the illumination unit 30 is switched from the initial amount of light Iᵢₙₜ to the target amount of light I_{tgt}, the processing is performed under the control of the processing unit 60 in accordance with the routine which is shown in FIG. 7.

In FIG. 7, it is judged if the type of the sensor panel assembly 10 which is being inspected has been changed (S21). If the type has not been changed (at S21, NO), the inspection processing is continued using the recipe as it is. On the other hand, if the type of the sensor panel assembly 10 which is being inspected is changed (at S21, YES), the recipe which had been used up to now is changed to a recipe which is suitable for inspection of the sensor panel assembly 10 after the change (S22). Note that, this recipe becomes a suitable one under the environment of a predetermined amount of illumination light (target amount of light I_{tgt}). Furthermore, at the time of inspection of a new type, it is judged if the set amount of light has to be switched (control for adjustment of light) (S23). In particular, if not necessary for switching the set amount of light (at S23, NO), inspection of this new type of sensor panel assembly 10 is continued using the new recipe.

On the other hand, when the set amount of light has to be switched due to switching of the type (at S23, YES), the set amount of light of the illumination unit 30 is switched from the initial amount of light Iᵢₙₜ (the amount of illumination light up to now) to the target amount of light I_{tgt} suitable for inspection of that type (S24). This being so, the amount of the light which is actually emitted from the illumination unit 30 (the amount of illumination light) gradually changes from the initial amount of light Iᵢₙₜ (see FIG. 5A, FIG. 5B). In the process, in the time period where the elapsed time from when the set amount of light is switched does not reach the first time t1 (at S25, YES), the correction information F which corresponds to the time period of the first time t1 from the time of switching is selected from the correction information file which is stored in the storage unit 64, and that selected correction information F is used to correct the original recipe (suitable recipe under environment at the target amount of light I_{tgt}) and prepare (determine) the corrected recipe (S26: included in the processing information determining means). That is, the correction file which is stored in the storage unit 64 is used as the basis to obtain the corrected recipe (processing information). Further, inspection processing is performed using the corrected recipe on the image of the sensor panel assembly 10 which is expressed by the test image data which is obtained based on the image signal from the line sensor camera 41 which scans the sensor panel assembly 10 which is illuminated by the amount of illumination light Iₓ at that time (S27: inspection processing execution step). In the time period of the first time t1 from the time of switching of the set amount of light (S24), the inspection processing using the corrected recipe which is corrected based on the correction information F which corresponds to that time period is continued.

If the elapsed time from when the set amount of light is switched exceeds the first time t1 (at S25, NO), in the time period until the elapsed time reaches the second time t2 (at S28, YES), the correction information F which corresponds to the time period from when the first time t1 elapses from when the set amount of light is switched until the second time t2 is reached is selected from the correction information file which is stored in the storage unit 64 and, in the same way as the above-mentioned processing, the selected correction information F is used to correct the original recipe and prepare the corrected recipe (S29: included in processing information determining means). Further, the image of the sensor panel assembly 10 is processed for inspection using that corrected recipe (S27: inspection processing execution step).

Furthermore, if the elapsed time from when the set amount of light is switched exceeds the second time t2 (at S28, NO), it is deemed that the amount of illumination light of the illumination unit 30 has reached the target amount of light I_{tgt} and the image of the sensor panel assembly 10 is processed for inspection using the original recipe (suitable recipe under environment of target amount of light I_{tgt}) (S30). After that, for that type, the original recipe is used to continue the inspection processing.

According to the above-mentioned such inspection system, when the set amount of light of the illumination unit 30 is switched from the initial amount of light Iᵢₙₜ to the target amount of light I_{tgt}, a corrected recipe which changes in accordance with the change of the amount of illumination light from the illumination unit 30 in the time from the initial amount of light Iᵢₙₜ to the target amount of light I_{tgt} is used for inspection processing on the image of the sensor panel assembly 10 obtained from the line sensor camera 41 (test image data), so even if using the illumination unit 30 which includes the high brightness LED unit 311 with the relatively long time required for the amount of illumination light to reach the target amount of light I_{tgt} when the set amount of light is switched from the initial amount of light Iᵢₙₜ to the target amount of light I_{tgt} and starting inspection before the amount of illumination light of the illumination unit 30 reaches the target amount of light, it is possible to perform good precision inspection compared with the past.

Note that, in the above-mentioned embodiment of the present invention, the processing for preparing a correction information file in accordance with the routine which is shown in FIG. 6 and using the correction information file to prepare a corrected recipe (see FIG. 7) corresponds to the processing information determining means (processing information determining step) of the present invention for determining processing information which is used for the inspection processing which changes along with the change of the amount of illumination light from the illumination system from the initial amount of light to the target amount of light when the set amount of light of the illumination system is changed from the initial amount of light to the target amount of light.

In the above-mentioned inspection system, the correction information F which corrects the original recipe is stored linked with the elapsed time from the time of switching of the set amount of light, but the corrected recipe itself which is obtained by correction of the original recipe by the correction information F may also be stored linked with the elapsed time from the time of switching of the set amount of light. In this case, in actual operation, rather than producing a corrected recipe for each elapsed time after switching of the set amount of light, the inspection processing is performed using the corrected recipe which is read out from the storage unit 64 and corresponds to that time period.

Further, in the above-mentioned inspection system, the correction information F which corrects the original recipe is stored linked with the elapsed time from the switching of the set amount of light, but it may also be stored linked with the amount of illumination light which changes together with the elapsed time from the switching of the set amount of light. In this case, the patterns of switching the set amount of light at the time of switching the type of the sensor panel assembly 10 being inspected are extracted in advance from an inspection schedule. A correction information file which links these with the amount of illumination light which changes along with the elapse of time of all of the patterns is prepared. Note that, when storing correction information F linked with the elapsed time from when switching the set amount of light, the correction information F is made to be set for each time period, but in the same way as when storing correction information F linked with the amount of illumination light, it is also possible to divide the amount of illumination light which changes from when the set amount of light is switched into a plurality of illumination light sections and set the information for each illumination light section.

Further, in actual operation, the amount of illumination light from the illumination unit 30 is switched to the target amount of light I_{tgt} and the amount of illumination light gradually changes from the initial amount of light Iᵢₙₜ to the target amount of light I_{tgt}. In the process, for example, illumination light characteristics QDOWN, QUP which are shown in the FIG. 5A and FIG. 5B are used as the basis to successively select the correction information F linked with the amount of illumination light from the correction information file and prepare a corrected recipe or an illuminometer is set at part of the movement mechanism 50 and the output value of this illuminometer is used as the basis to select the correction information F corresponding to that output value from that correction information file and prepare a corrected recipe and the image of the sensor panel assembly 10 is processed for inspection using that corrected recipe.

Note that, as the above-mentioned correction information, among the items of the recipe which shows various criteria (including threshold values etc.), items which end up changing in criteria due to fluctuations in the amount of illumination light may be mentioned. For example, an inspection system which classifies the sizes of the bubbles which are detected as defects based on the image information of the inspected object as 10 μm or less, 11 μm to 20 μm, and 21 μm to 30 μm and inspects the numbers of the same is assumed. In this case, all of the detected bubbles are classified based on their detected sizes under suitable amounts of light.

For the contents above-mentioned, as shown in FIG. 5A, in the middle tₓ of change when switching the set amount of light from the initial amount of light Iᵢₙₜ to the target amount of light I_{tgt} lower than that, an amount of illumination light which is larger than the target amount of light I_{tgt} is illuminated on the inspected object. In the image of the inspected object captured at this stage, bubbles tend to be detected larger than their actual sizes. Therefore, for example, bubbles with sizes detected as 15 μm or less are counted as bubbles with sizes of 10 μm or less, bubbles with sizes detected as more than that to 28 μm are counted as bubbles with sizes of 11 μm to 20 μm, and bubbles with sizes detected as more than that to 36 μm are counted as bubbles with sizes of 21 μm to 30 μm. In this case, the criteria (threshold values) 15 μm, 28 μm, and 36 μm of the sizes of the bubbles correspond to the correction information linked with tₓ.

On the other hand, as shown in FIG. 5B, in the middle tₓ of change when switching the set amount of light from the initial amount of light Iᵢₙₜ to the target amount of light I_{tgt} higher than that, an amount of illumination light which is smaller than the target amount of light I_{tgt} is illuminated on the inspected object. In the image of the inspected object captured at this stage, bubbles tend to be detected smaller than their actual sizes. Therefore, for example, bubbles with sizes detected as 8 μm or less are counted as bubbles with sizes of 10 μm or less, bubbles with sizes detected as more than that to 15 μm are counted as bubbles with sizes of 11 μm to 20 μm, and bubbles with sizes detected as more than that to 20 μm are counted as bubbles with sizes of 21 μm to 30 μm. In this case, the criteria (threshold values) 8 μm, 15 μm, and 20 μm of the sizes of the bubbles correspond to the correction information linked with tₓ.

Note that, the set values of the above-mentioned such correction information can be determined by using a test member with known actual dimensional values and other values, obtaining an image of the test member for each elapsed time or for each change in amount of illumination light after switching the set amount of light, using that for measurement, and comparing the detected values and the actual dimensional values.

Further, in the above-mentioned example, the correction information F corresponding to the elapsed time from when the set amount of light was switched from the initial amount of light Iᵢₙₜ to the target amount of light I_{tgt} is prepared in accordance with the processing of FIG. 6, but it is also possible to use the obtained plurality of correction information as the basis to compute correction characteristic information corresponding to the characteristic of the recipe which changes in accordance with the elapsed time (expressing characteristic of change of processing information). In this case, there is no need to store the correction information F corresponding to each time period in the storage unit 64. In actual operation, it is possible to calculate (produce) the corrected recipe corresponding to the switching time of the set amount of light based on the correction characteristic information.

In the above-mentioned inspection system, the recipe (image inspection criteria) which is used for the inspection processing is the processing information changing along with the time of change of the amount of illumination light from the initial amount of light to the target amount of light, but the invention is not limited to this. For example, it is possible to make a correction coefficient with respect to pixel values of the image data which expresses the image of the inspected sensor panel assembly 10 the processing information changing along with the time of change of the amount of illumination light from the initial amount of light to the target amount of light. In this case, in the processing which is shown in FIG. 6, instead of the correction information F, a correction coefficient for the pixel values of the image data is prepared (determined). As a general trend, in the state where the amount of illumination light Iᵢₙₜ is lower than the target amount of light I_{tgt} (for example, see FIG. 5B), the correction coefficient is determined so that the brightness of the pixel values of the image data becomes higher, while in the state where the amount of illumination light Iₓ is higher than the target amount of light I_{tgt} (for example, see FIG. 5A), it is determined so that the brightness of the pixel values of the pixels of the image data become lower. Further, in actual operation, until the amount of illumination light reaches the target amount of light I_{tgt}, the brightness of the pixels values of the obtained image data is corrected (determined) using the correction coefficient and the inspection processing for the image of the sensor panel assembly 10 expressed by the corrected image data which is obtained by that correction is performed using the original recipe (the recipe which is determined under the environment of the target amount of light I_{tgt}).

Further, for example, the gain information of the image signal which is output from the line sensor camera 41 which captures the inspected sensor panel assembly 10 may be made the processing information changing along with the time of change of the amount of illumination light from the initial amount of light to the target amount of light. In this case, in the processing which is shown in FIG. 6, instead of the correction information F, gain information which is to be set at the level adjustment circuit 63 is prepared (determined). As a general trend, in the state where the amount of illumination light Iₓ is lower than the target amount of light I_{tgt} (for example, see FIG. 5B), the gain information is determined so that the level of the image signal which is supplied to the processing unit 60 becomes higher and, further, in the state where the amount of illumination light Iₓ is higher than the target amount of light I_{tgt} (for example, see FIG. 5A), it is determined so that the level of the image signal which is supplied to the processing unit 60 becomes lower. Further, in actual operation, until the amount of illumination light reaches the target amount of light I_{tgt}, the level of the image signal which is output from the line sensor camera 41 is adjusted by the gain information which is set at the level adjustment circuit 63 and that level adjusted image signal is supplied to the processing unit 60. After that, in the processing unit 60, the level adjusted image signal is used as the basis to obtain the image data and the image of the sensor panel assembly 10 which is expressed by the image data is processed for inspection by using the original recipe.

As explained above, when correcting or adjusting the image data or the image signal as well, in the same way as when correcting the recipe, it is possible to perform good precision inspection compared with the past even if using an illumination unit 30 including a high luminance LED unit 311 which requires a relatively long time for the amount of illumination light of the illumination unit 30 to reach a target amount of light I_{tgt} when the set amount of light of the illumination unit 30 is switched from the initial amount of light Iᵢₙₜ to the target amount of light I_{tgt} and starting the inspection before the amount of illumination light of the illumination unit 30 reaches the target amount of light.

Further, in the above-mentioned inspection system, the recipe (image inspection criteria) and correction coefficient or gain information which are used for the inspection processing are made the processing information changing along with the time of change of the amount of illumination light from the initial amount of light to the target amount of light, but it is possible to make shading correction information which corrects unevenness of illumination of the illumination unit 30 (unevenness of illumination in position) or unevenness of sensitivity of the devices of the line sensor which is provided in the line sensor camera 41 (camera unit) (unevenness of sensitivity in position) the processing information changing along with the time of change of the amount of illumination light from the initial amount of light to the target amount of light. Usually, in the above-mentioned such inspection system, at the stage of adjustment of the system, the shading correction is performed for devices of the line sensor camera 41 so that the unevenness of illumination of the illumination unit 30 or the unevenness of sensitivity of the devices of the line sensor which is arranged at the line sensor camera 41 becomes the minimum. After adjustment (processing of actual operation), the shading correction information at the stage of adjustment explained above is applied and inspection is performed. However, the optimal shading correction information changes depending on the amount of illumination light, so to enable more precise inspection, it is preferable to use the shading correction information under the amount of illumination light which is actually emitted.

In this case, for example, in FIG. 2, the inspected sensor panel assembly 10 is retracted to a position which the illumination light from the illumination unit 30 strikes. Further, in this state, the amount of illumination light from the illumination unit 30 is made to change from zero to the maximum value, the amount of illumination light during that is divided into 10 equal parts, the shading correction is individually performed in accordance with the amount of illumination light at each point, and shading correction information linked with the amount of illumination light is prepared (determined). In this case, the shading correction information is changed, for example, at the time of replacement of the line sensor camera 41, the illumination unit 30, etc.

Further, as explained above, patterns of switching the set amounts of light at the times of switching the types of the sensor panel assembly 10 being inspected (patterns of switching from the initial amount of light Iᵢₙₜ to the target amount of light I_{tgt}) are extracted from the inspection schedule (patterns of switching from initial amount of light Iᵢₙₜ to the target amount of light I_{tgt}). A corrected recipe which corresponds to the amount of illumination light for each elapsed time (t1, t2, . . . ) from switching of all of the patterns is prepared and stored.

In actual operation, the set amount of light from the illumination unit 30 is switched to the target amount of light I_{tgt} and the amount of illumination light gradually changes from the initial amount of light Iᵢₙₜ to the target amount of light I_{tgt}. In the process, the shading correction information which corresponds to the elapsed time from when the set amount of light is switched or the shading correction information which corresponds to the amount of illumination light closest to the amount of illumination light which corresponds to that elapsed time is added to the corrected recipe which corresponds to that elapsed time and then the inspection processing is performed. That is, shading correction information which corresponds to the elapsed time from when the set amount of light is switched or to the amount of illumination light closest to the amount of illumination light corresponding to that elapsed time is selected and that shading correction information is used to correct the sensitivity of the devices of the line sensor which is provided at the line sensor camera 41. Further, from the line sensor camera 41, an image signal which has been corrected by shading correction in this way is supplied to the processing unit 60. After that, the processing unit 60 uses the image signal as the basis to produce image data and performs inspection processing on the image of the sensor panel assembly 10 which is expressed by that image data while using a corrected recipe corresponding to the elapsed time.

Note that, in the above-mentioned inspection system, the corrected recipe and shading correction information which change along with the change in time of the amount of illumination light from the initial amount of light Tᵢₙₜ to the target amount of light I_{tgt} are made the processing information, but the invention is not limited to this. The above-mentioned correction image data and shading correction information, the above-mentioned image signal and shading correction information, and other processing information combining processing information may also be used so that even if using an illumination system, like an illumination system which uses high brightness LEDs as a light source, where the time required for the amount of illumination light to reach a target amount of light when the set amount of light is switched from the initial amount of light to the target amount of light is relatively long, it is possible to perform inspection with a better precision than the past even if starting the inspection before the set amount of light of the illumination system reaches the target amount of light.

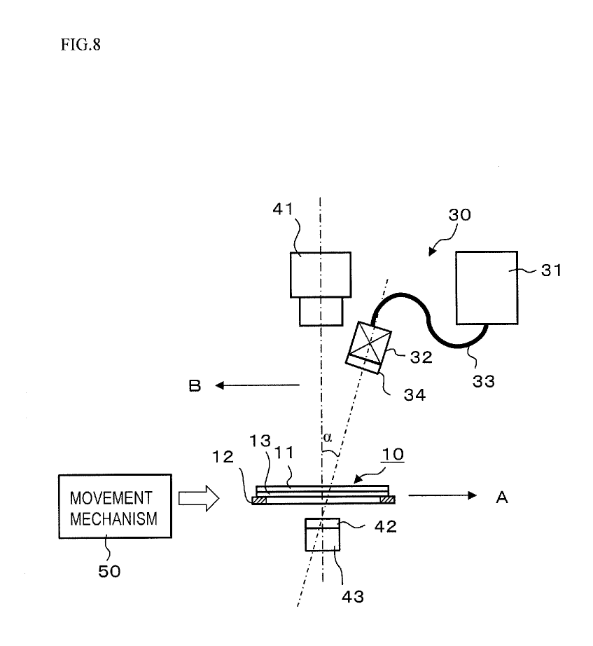

In the above-mentioned inspection system (see FIG. 2), to deal with the type of the inspected sensor panel assembly 10 which changes in transmission rate in various ways, as shown in FIG. 8, it is possible to add a specialized transmission illumination unit 43 which comprised of good response low brightness LEDs for control of light adjustment. This specialized transmission illumination unit 43 illuminates the sensor panel assembly 10 from the back of the reflector 42 which functions as a diffuser. In this case as well, for an illumination unit 30 which includes the high brightness LED unit 311, in the same way as explained above, when the set amount of light is switched from the initial amount of light Iᵢₙₜ to the target amount of light I_{tgt}, a corrected recipe (correction coefficient of image data and gain information of image signal) which is determined in accordance with the elapsed time from the time of switching is used for inspection processing.

### REFERENCE SIGNS LIST

10 sensor panel assembly (inspected object)
11 sensor panel
12 cover glass
13, 15 binder
20 liquid crystal panel assembly
30 illumination unit
31 light source device
32 illumination head
33 light guide
34 light condenser
41 line sensor camera
42 reflector (diffuser)
43 specialized transmission illumination unit
50 movement mechanism
60 processing unit
61 display unit
62 operating unit
63 level adjustment circuit
311 high brightness LED unit
312 light guide mirror
313 power source unit
314 cooling fan

What is claimed is:

1. An inspection system which has an illumination unit which illuminates an inspected object, a camera unit which captures said inspection object which is illuminated by said illumination system to output an image signal, and a processing unit which uses the image signal from said camera unit as the basis to generate image data which expresses an image of said inspected object and processes the image of said inspected object which is expressed by said image data for inspection,
said processing unit comprising:
a processing information determining unit determining processing information which is used for said inspection processing and changes along with the change in time of the amount of illumination light from the illumination system from the initial amount of light to the target amount of light when the set amount of light of the illumination system is changed from the initial amount of light to the target amount of light, wherein
said processing unit performs said inspection processing by using processing information which is determined by said processing information determining unit in accordance with the elapsed time from when the set amount of light of the illumination system is switched from the initial amount of light to the target amount of light.

2. The inspection system as set forth in claim 1 wherein the processing unit uses said processing information constituted by the image inspection criteria as the basis to process the image of said inspected object which is expressed by said image data for inspection, and
the processing information determining unit determines said image inspection criteria which changes in accordance with the change in time of the amount of illumination light from the illumination system from the initial amount of light to the target amount of light.

3. The inspection system as set forth in claim 1 wherein the processing information determining unit has
means for determining a correction coefficient of said image data which changes in accordance with the change of the amount of illumination light of the illumination system from the initial amount of light to the target amount of light and
uses said correction coefficient to determine the image data which is used for said inspection processing which changes along with the change in time of the amount of illumination light from the illumination system from the initial amount of light to the target amount of light.

4. The inspection system as set forth in claim 1 wherein the processing information determining unit has
means for determining gain information of the image signal from said camera unit which changes in accordance with the change in time of the amount of illumination light of the illumination system from the initial amount of light to the target amount of light and
uses said gain information to adjust the level of the image signal which is used for said inspection processing which changes along with the change in time of the amount of illumination light from the illumination system from the initial amount of light to the target amount of light.

5. The inspection system as set forth in claim 1 wherein
said processing unit uses shading correction information for correcting unevenness of illumination in position of the illumination system and/or unevenness of sensitivity in position for the incident light of said camera unit as said processing information to produce said image data and processes the image of said inspected object which is expressed by said produced image data for inspection processing, and
said processing information determining unit determines said shading correction information which changes in accordance with change in time of the amount of illumination of the illumination system from the initial amount of light to the target amount of light.

6. The inspection system as set forth in claim 1, wherein said processing information determining unit has
a storage means for storing information for obtaining the processing information corresponding to each of a plurality of time periods at elapsed time from when the set amount of light of the illumination system is switched from the initial amount of light to the target amount of light and
means for obtaining the processing information corresponding to the elapsed time from when the set amount of light of the illumination system is switched from the initial amount of light to the target amount of light based on the information which is stored in said storage means.

7. The inspection system as set forth in claim 1, wherein said processing information determining unit has
means for using the processing information which corresponds to each of a plurality of timings in an elapsed time from when the set amount of light of the illumination system is switched from the initial amount of light to the target amount of light as the basis to obtain a changed characteristic of the processing information which corresponds to the elapsed time from when the set amount of light of the illumination system is switched from the initial amount of light to the target amount of light and for using the changed characteristic of the processing information as the basis to produce the processing information which corresponds to the elapsed time from when the set amount of light of the illumination system is switched from the initial amount of light to the target amount of light.

8. An inspection method which performs an inspection processing to an image of an inspected object which is expressed by image data obtained by capturing the inspected object by a camera unit, the inspected object being illuminated by an illumination system, said inspection method comprising:
a processing information determining step of determining processing information which is used for said inspection processing and changes along with the change in time of the amount of illumination light from the illumination system from the initial amount of light to the target amount of light when the set amount of light of the illumination system is changed from the initial amount of light to the target amount of light and
an inspection processing execution step of performing said inspection processing by using processing information which is determined by said processing information determining step in accordance with the elapsed time from when the set amount of light of the illumination system is switched from the initial amount of light to the target amount of light.

9. The inspection method as set forth in claim 8 wherein said processing information determining step has
a step of storing information for obtaining processing information corresponding to each of a plurality of time periods at elapsed time from when the set amount of light of the illumination system is switched from the initial amount of light to the target amount of light in storage means and
a step of obtaining processing information corresponding to the elapsed time from when the set amount of light of the illumination system is switched from the initial amount of light to the target amount of light based on information which is stored in said storage means.

10. The inspection method as set forth in claim 8 wherein said processing information determining step has
a step of using processing information which corresponds to each of a plurality of timings in an elapsed time from when the set amount of light of the illumination system is switched from the initial amount of light to the target amount of light as the basis to obtain a changed characteristic of the processing information which corresponds to the elapsed time from when the set amount of light of the illumination system is switched from the initial amount of light to the target amount of light and of using this as the basis to produce processing information which corresponds to the elapsed time from when the set amount of light of the illumination system is switched from the initial amount of light to the target amount of light.
